(19) United States
(12) Patent Application Publication
(10) Pub. No.: US 2007/0171524 A1
(43) Pub. Date: Jul. 26, 2007

(54) FOCUSING MECHANISM FOR STEREOSCOPIC SYSTEMS

(75) Inventors: M. Gregory Steinthal, Los Angeles, CA (US); Behrokh Khoshnevis, Marina Del Ray, CA (US); David Sherlock, Glendale, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Stereo Vision Imaging, Inc., Alta Dena, CA (US)

(21) Appl. No.: 11/556,616

(22) Filed: Nov. 3, 2006

Related U.S. Application Data
(63) Continuation-in-part of application No. 10/655,228, filed on Sep. 3, 2003, now abandoned.
(60) Provisional application No. 60/408,186, filed on Sep. 3, 2002.

(51) Int. Cl. G02B 27/22

(52) U.S. Cl. 359/466

(57) ABSTRACT

A hand held stereoscopic system in which the focusing to the eye and image detector of images of near and distant objects are adjusted simultaneously by moving the objective lens system. Fine adjustments of the focus of images provided to the image detector are also performed automatically.

### CROSS-REFERENCES TO RELATED APPLICATIONS

This application is a continuation-in-part (CIP) of U.S. patent application Ser. No. 10/655,228, titled FOCUSING MECHANISM FOR STEREOSCOPIC SYSTEMS, filed Sep. 3, 2003 (Attorney docket No. 022420-000110US), which claims the benefit of U.S. patent application No. 60/408,186, filed Sep. 3, 2002, (Attorney docket No. 022420-000100US), the disclosures of which are incorporated herein by reference in their entirety.

### BACKGROUND OF THE INVENTION

The present invention relates in general to stereoscopic imaging systems, and more particularly to focusing mechanisms for stereoscopic imaging systems.

The use of prisms to produce enlarged images of distant objects dates back centuries, beginning, according to the history books, when Galileo first held up two prisms and gazed through them. Soon, the appropriated juxtaposed prisms were incorporated into elongated telescopes through which the viewer peered using one eye. The image presented was, of course, flat, consisting of only two dimensions. Much later, it was realized that by holding a telescope to each eye, a stereoscopic image was perceived. However, holding up two telescopes at the same time was not particularly easy, and was definitely not very convenient, thus the same technology was incorporated into what was to become the now well-known pair of hand-held binoculars.

Conventional binoculars typically include two small refracting telescopes held together by a frame that positions the telescopes, one to each of the viewer's eyes. Because the binocular incorporates a separate telescope for each eye, it therefore produces a stereoscopic or three-dimensional view that adds “depth” to the image as perceived in the viewer's brain.

Each refracting telescope in the binocular defines an optical path through an objective lens at the end nearest the object being viewed, a pair of prisms appropriately arranged within the telescope's tubular body, and an eye piece that is at the end nearest the viewer's eye. The diameter of the objective lens determines the light-gathering power of a telescope. The objective lenses (in the two adjacent telescopes) are often spaced farther apart than the eyepieces so as to enhance stereoscopic vision. Functioning as a magnifier, the eyepiece forms a large virtual image that becomes the object for the eye itself and thus forms the final image on the retina. Because of the spacing between the objective lenses, the object is “viewed” from a slightly different angle by each lens and therefore collects a slightly different image. Thus, the image projected onto the retina of each eye is also slightly different, and when the viewer's brain incorporates and melds the two slightly different images received through both eyes, the viewer perceives a unified but 3-dimensional (3-D) or stereoscopic image.

Binoculars are used throughout the world in many, many human endeavors from bird watching to opera-going to star-gazing. Over the years since the binocular was first introduced, many improvements have been made. Until recently, however, these improvements related mainly to refinements in the quality of a binocular's basic component parts, such as improving the optical components to produce clearer images, increasing magnification, adding image stabilization, making them adjustable, making them more durable, making them smaller, making them more ergonomically balanced, adding low light gathering capability, etc.

The focusing mechanism used in traditional binoculars is typically controlled by moving the eyepieces back and forth by a knob located centrally between the two refracting telescope channels. Binoculars include other optical elements to focus the images to the eyes of a user. These other optical elements (e.g., lenses), are typically located between the eyepieces and prisms or between the objective lenses and the prisms in each telescope channel and are typically moved using the focusing knob.

Accordingly, there is a need in the art for a system that offers improved focusing mechanisms that are useful in all traditional binocular pairs or other stereoscopic imaging systems.

### BRIEF SUMMARY OF THE INVENTION

The present invention is generally directed to dual focusing mechanisms for hand-held stereoscopic imaging systems. More specifically, the invention relates to simultaneously focusing stereo images to a user's eyes, and to a stereoscopic imaging system (e.g., solid state system) housed within a traditional hand-held pair of prism binoculars.

The present invention in certain aspects, provides systems for focusing a stereoscopic device by moving the objective lenses or prisms the same distance simultaneously. The stereoscopic device can be a hand-held optical viewing device, a 3-dimensional imaging system or a pair of binoculars. The movement of the objective lenses or prisms in concert operates to simultaneously focus near and distant objects to a user's eye and to an image detector. The image detector can be a complementary metal oxide semiconductor (CMOS) photo array, a charge coupled device (“CCD”) or any other type of optical sensor. In certain aspects, the objective lenses are moved to provide focus. Unlike in conventional binoculars, the distance between the objective lenses is adjustable without any pivoting action. This is useful, for example, when a digital camera or other imaging device is mounted on the same platform that holds the objective lens. A pivoting action in this case moves the camera and hence tilts the image. The reciprocal motion in the present invention prevents such problems.

According to one embodiment, a hand-held stereoscopic optical viewing device includes 2 refracting telescopes each having an objective lens or prism and eyepiece which is mounted on a frame. This viewing device could be a 3-dimensional imaging system, an optical viewing system or a pair of binoculars. The device in certain aspects also contains an embedded stereoscopic imaging or optical viewing system that includes an image detector, such as a CMOS photo array, charge coupled device or optical sensor, and imaging optics to record images. The embedded stereoscopic imaging or optical viewing system thus defines an optical path. A focusing mechanism simultaneously focuses the images to the eyepiece and to the embedded stereoscopic imaging system either automatically or manually.

According to another embodiment, fine focus of the images to an image detector is provided. In certain aspects, a fine focusing mechanism is provided to automatically adjust the focus of images provided to the image detectors. In one aspect, the mechanism includes a stepper motor, associated gearing, a focusing lens assembly (one for each image channel) including one or more lenses, and a gear drive shaft. Movement of one or more lenses in the lens assembly takes place when a user pushes a shutter button to capture an image. Similar to digital camera technology, fine tuning occurs and the image is then captured.

According to one aspect of the present invention, movement of the objective lenses occurs either automatically or manually in concert with each other over the same distance.

According to another aspect of the present invention, movement of the objectives lenses is controlled by a knob to allow fine tuning to the eye and gross adjustment to the imaging device.

According to another aspect of the present invention, movement of an objective lens is electrically motorized and controlled by a switch/button. Further, the image provided to the imaging devices are auto-focused, independent of the overall system (e.g., binocular system) to allow for proper image capture. In certain aspects, auto-focus is implemented using feedback algorithms implemented in a processor or intelligence module.

According to another aspect of the present invention, the focusing mechanism that adjusts the positions of the objective lenses includes a bar, knob, wire system and/or a knob, linear slide, and chain system. Devices incorporating aspects of the present invention can be used for outdoor/indoor 3-D viewing, with focusing achieved by moving the objective lenses.

Reference to the remaining portions of the specification, including the drawings and claims, will realize other features and advantages of the present invention. Further features and advantages of the present invention, as well as the structure and operation of various embodiments of the present invention, are described in detail below with respect to the accompanying drawings. In the drawings, like reference numbers indicate identical or functionally similar elements.

### BRIEF DESCRIPTION OF THE DRAWINGS

FIG. 1 is a perspective view of a stereoscopic imaging device according to one embodiment.

FIG. 2 is another perspective view of the stereoscopic imaging device of FIG. 1.

FIG. 3 is an internal top view of the present invention illustrating the objective lens and focusing mechanism according to one embodiment.

FIG. 4a shows an alternative focusing mechanism design using bevel gears and lead screws.

FIG. 4b shows a top perspective view of one half of a stereoscopic imaging system including objective lens 2A, eyepiece 1A, and an embedded image detector.

FIG. 5 illustrates a fine focusing mechanism for adjusting the focus of an image provided to an image detector according to one embodiment.

FIG. 6 illustrates a schematized block diagram of electronic circuitry contained in a printed circuit board according to one embodiment.

FIG. 7 illustrates a process of fine focusing images provided to the imaging detector according to one embodiment.

### DETAILED DESCRIPTION OF THE INVENTION

Embodiments of the present invention provide systems and methods for focusing a near or distant object simultaneously to the eyes and to an imaging system in a stereoscopic device by moving the objective lenses. The end user fine tunes the image to the eye via his/her comfort level which in effect also provides a gross focus adjustment to the imaging system. The imaging system can be embedded in the device housing and may include any optical sensor and imaging devices and optics to record images, such as CCD photo arrays or charge coupled devices. The imaging optics are automatically adjusted to provide fine focusing to the imaging devices. The manual focus to the eye and imaging systems are common. The auto focus system to the imaging devices operate independently from the manual focus.

A stereoscopic effect is the creation of the illusion of three dimensions (that is, the appearance of depth or solidity) in a two-dimensional image. Superimposing two different views of the same scene to form a composite image, the composite being at the point where the two lines of sight cross one another, can create this effect. If the two views are laterally displaced from one another by an amount approximately equal to the distance between the viewer's eyes, the resulting image will have essentially the same three-dimensional appearance as if the viewer were seeing the scene with the naked eye. Where the separation is greater than that between the viewer's eyes, the three-dimensional effect is exaggerated. Similarly, if the distance is less, the three-dimensional effect is lessened or minimized. As mentioned above, humans and most animals achieve this effect naturally because their eyes are spaced a distance apart. The image seen by each eye is at a slightly different angle or perspective relative to the object being viewed. When these two images are “superimposed” within the brain, the image perceived is three-dimensional. To maintain this stereoscopic imagery during magnification, conventional binoculars were developed.

For this reason, today's existing hand-held binoculars are a perfect platform upon which to integrate a solid-state stereoscopic imaging system. The binocular optics needed to create the 3-D effect are already in place, the distance between the eye pieces has been optimized, and binoculars in general have passed the test of time for improved image enhancement, ergonomics, comfort and reliability. Therefore, the basic components of the conventional binoculars form the framework within which the inventive elements herein described are incorporated.

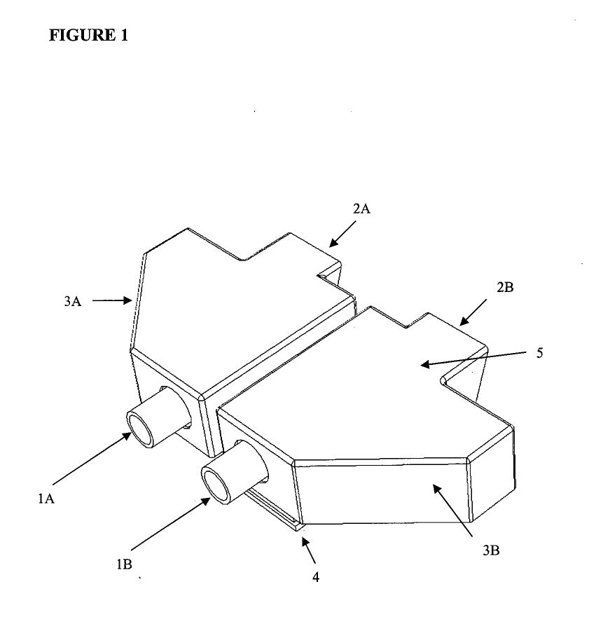

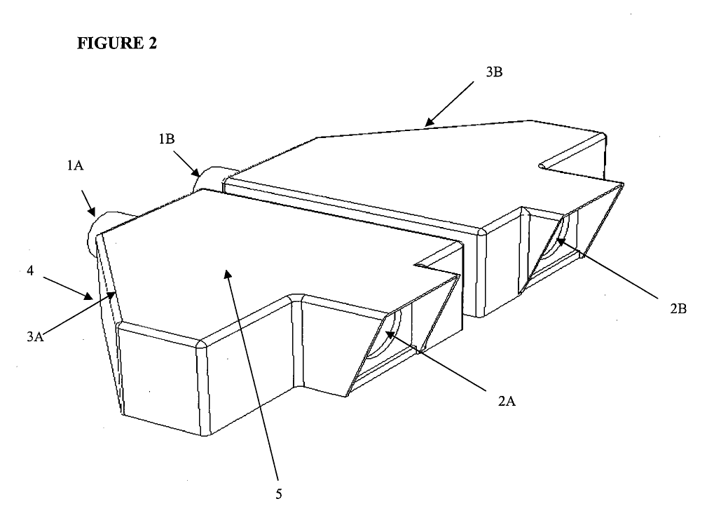

FIG. 1 is a perspective view of a stereoscopic imaging device according to one embodiment. FIG. 2 is another perspective of the stereoscopic imaging device of FIG. 1. The stereoscopic imaging device includes two small refracting telescopes 3A and 3B that are held together by a frame or housing 4 that, by definition, holds the telescopes 3A and 3B sufficiently far apart such that a stereoscopic or three-dimensional view is produced when their separate images are superimposed on one another. As in most binoculars, the frame 4 allows the distance between the telescopes 3A and 3B to be adjusted so as to accommodate the differences in the distance between the eyes of different users. As with the traditional binoculars, the externally visible components include the objective lenses 2A and 2B at the distal end of each of the telescopes 3A and 3B, and eyepieces 1A and 1B.

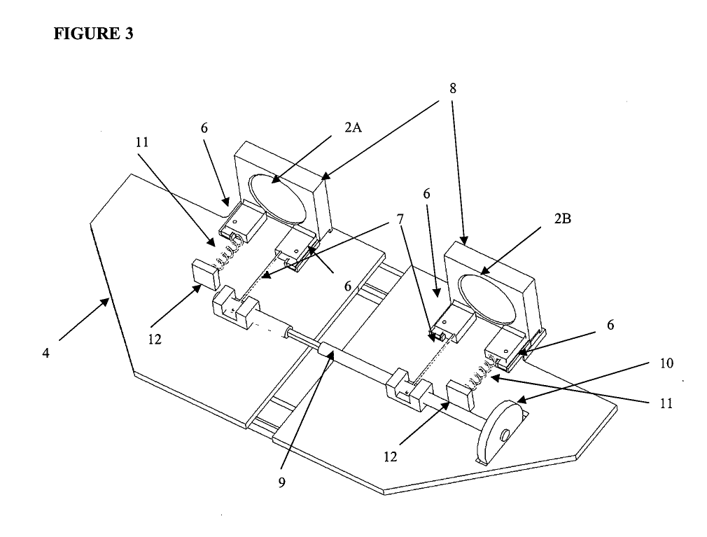

FIG. 3 is an internal view of the stereoscopic imaging device of FIG. 1 including a focusing mechanism according to one embodiment. As shown, the focusing mechanism includes a knob 10 which when turned rotates the bar 9. When the bar 9 turns, the wires 7 wrap around the bar which causes the linear ball slides 6 connected to the objective lens holders 8 to move simultaneously. The objective lenses 2A and 2B in the objective lens holders 8 move back and forth using tension from springs 11 attached to the frame 4, a spring stop 12 and the objective lens holders 8 via screws. In certain aspects, the bar 9 is made out of two telescopic pieces; the outside surfaces of these pieces where the tension wire 7 is wound are tubular and of the same diameter. In one aspect, one bar 9 has a square hole along its length while the other has a matching square bar that goes into the square hole. This allows for coordinated rotational motion for focusing to the eye and to an image detector (e.g., a CMOS photo array) as well as reciprocal motion for eye distance adjustment.

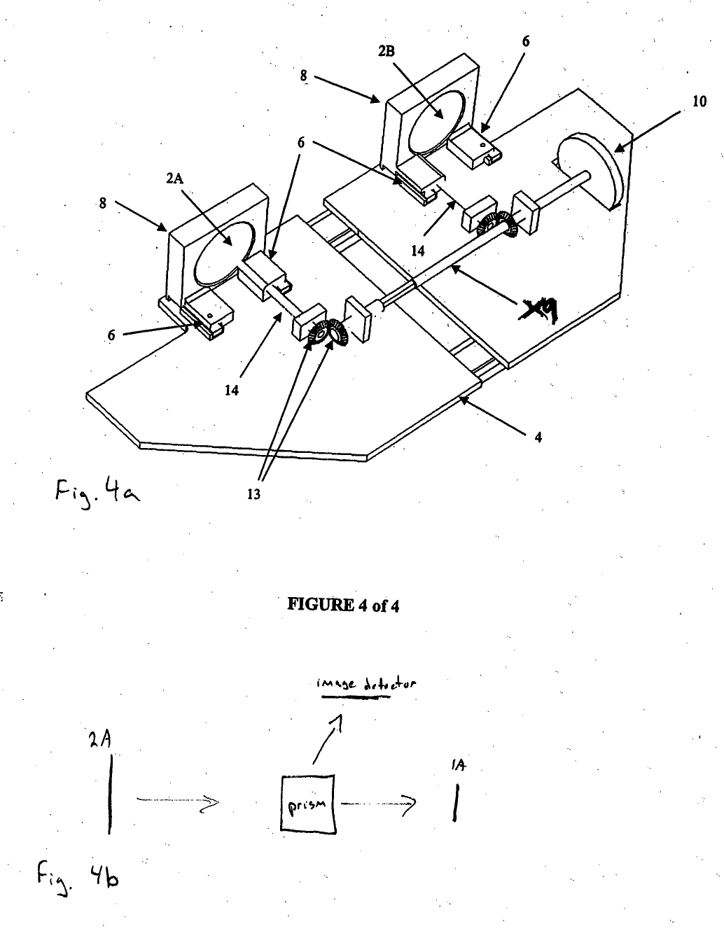

FIG. 4a shows an alternative focusing mechanism design including bevel gears 13 and lead screws 14. This design is more robust and requires no springs or other biasing mechanism. The focusing mechanism includes a knob 10 which when turned rotates the bevel gears 13 which turn the lead screws 14. When the lead screws 14 turn, the linear ball slides 6 connected to the objective lens holders 8 move simultaneously thereby moving the objective lenses 2A & 2B simultaneously. The objective lenses 2A and 2B in the objective lens holders 8 move back and forth using the bevel screws 13 and the lead screws 14. In certain aspects, the lead screws 14 are made out of two telescopic pieces. In one aspect, one lead screw 14 has a square hole along its length while the other has a matching square bar that goes into the square hole. This allows for coordinated rotational motion for focusing to the eyes and to the image detector (e.g., a CMOS photo array) as well as reciprocal motion for eye distance adjustment. FIG. 4b shows a top perspective view of one half of a stereoscopic imaging system including objective lens 2A, eyepiece 1A, and an embedded image detector.

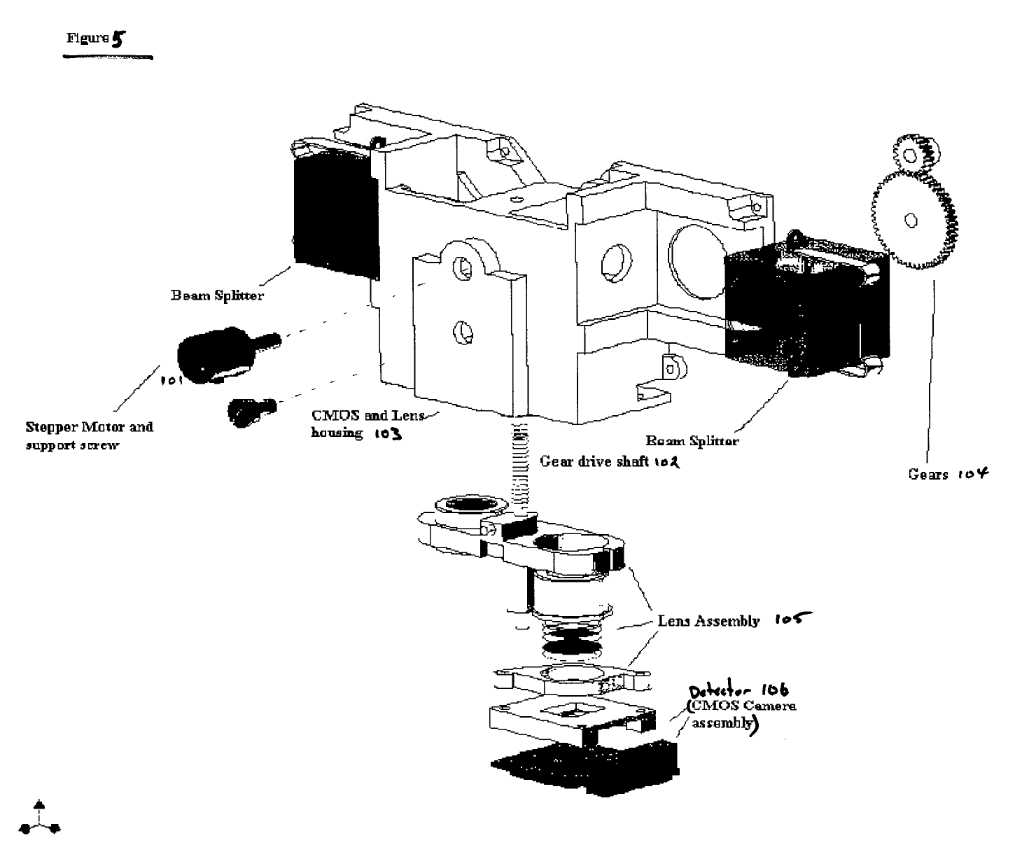

FIG. 5 illustrates elements of a fine focusing mechanism according to one embodiment. As shown, the fine focusing mechanism includes a stepper motor 101, gears 104, and a gear drive shaft 102 configured to move the focusing lens assembly 105 to provide fine focus of the image onto the image detector 106. Image detector 106 may include a CMOS or CCD photo array or other imaging devices. In operation, a user depresses a shutter button which in turn causes a stepper motor 101 to activate, which controls motion of gears 104. Movement of gears 104 causes gear shaft 102 to turn, thereby moving focusing lens assembly 105 so as to fine focus the image onto the image detector 106. In certain aspects, one or more lenses in each focusing assembly 105 move. For example, when a user depresses a picture capture button, the fine focus lenses move and an actual photo is taken. Both lens assemblies move the same amount for each image detector. The fine focus is automatically adjusted via the stepper motor and gearing under the control of a processor element, e.g., processor chip, FPGA, ASIC, etc. that provides control signals to the stepper motor. The degree of focusing is determined using mathematical algorithms. For example, a memory coupled with the processor element may store the algorithms for use by the processor element or the algorithms may be implemented in hardware and/or firmware. An enclosure or housing 103 is provided for stability.

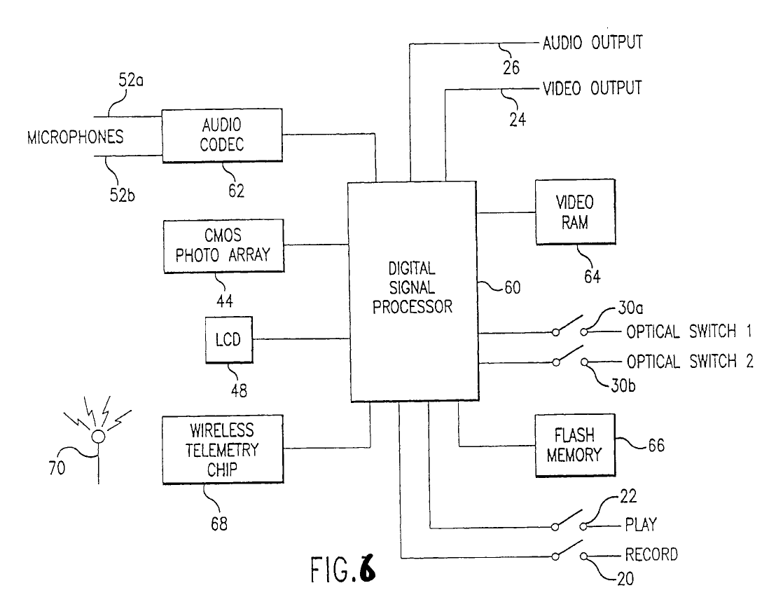

FIG. 6 is a schematized block diagram of a processor element and other electronic circuitry according to one embodiment. Some or all of the circuitry elements shown in FIG. 6 may be contained in a printed circuit board. In certain aspects, the Digital Signal Processor 60 is responsible for providing control signals to the stepper motor 101 and also for enabling/disabling the image sensor 106, e.g., a CMOS photo sensitive array 44, the LCD 48, the optical switches 38a and 38b and the microphones 52, which are triggered by the record and playback buttons 20 and 22, respectively. The audio codec chip 62 digitizes audio information picked up by the microphones 52. This information is stored by the processor 60 as a sound file associated with the video information that was recorded at the same instant in time. The DSP 60 is also responsible for image compression, color correction and other signal processing tasks. For temporary data calculations, video RAM 64 may be included. The images are stored in flash replaceable memory 66. Information can also be uploaded from flash memory 66 to the playback function of the device if desired. The information may be overlaid so that the information is displayed while viewing the outside world or perhaps one channel views the outside world, while the other channel displays information for image recognition images. For example, as an exotic bird is seen while bird watching, the other channel can be uploading information from a library of exotic birds, so that a match can be made and the bird's identity can be determined in real time.

The processor 60, in certain aspects, is also responsible for image stabilization, e.g., if the binocular magnification power is high enough to cause any image distortions. A digital video output is provided to a video I/O port 24. An analog output is provided through a digital-to-analog converter to an audio output jack 26. With conventional and appropriate wire connections (not shown), the signal from output jack 26 can be used to drive an external pair of speakers or headphones so that the user of the device can hear the stored and replayed signal at the same time he or she is watching the replay of the stored video information.

In certain aspects, a wireless telemetry chip 68 is included to provide the capabilities to receive and transmit information remotely for real-time stereoscopic playback via LCD 48 within the device or to capture information in stereo via the image sensor 44 and transmitted to a remote processor node tied to the Internet or other network. The wireless telemetry chip 68 modulates the field sequential signal for wireless transmission via attached antenna 70.

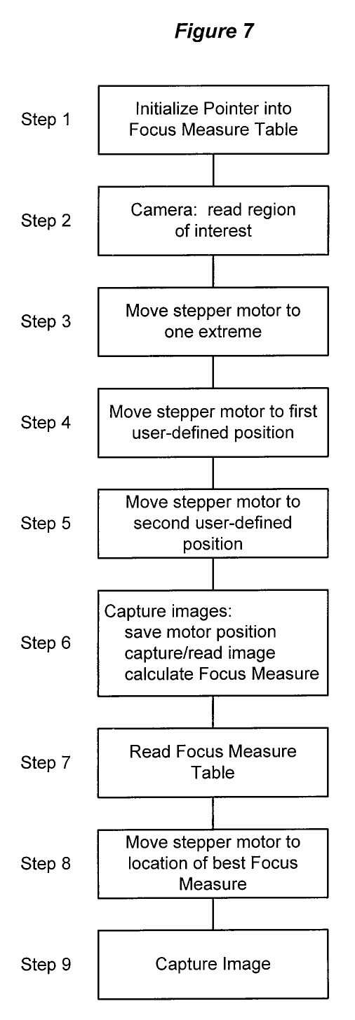

FIG. 7 illustrates a process of fine focusing images provided to the imaging detector according to one embodiment. The process is implemented in the processor element, e.g., FPGA or other task, which provides commands to control the stepper motor (AF motor) to move to specific locations, automatically performing ramp-up and ramp-down. Inputs typically include a user defined motor start position and a user define motor end position. As used herein, a “Focus Measure” defines the sharpness of the image and the best focus measure thus points to the image in best focus to the users eyes. In step 1 a pointer into a table of Focus Measure vs. stepper motor location is initialized. In step 2 a camera mode is set to read the region of interest only. In step 3 the AF (stepper) motor is controlled to move in the direction to the contact closure that indicates one extreme of travel range. In certain aspects, maximum speed is used. In step 4, the AF motor proceeds to a user-defined motor position. In step 5, the motor is controlled to travel in the opposite direction toward the other extreme end of user-defined travel range. In step 6, images are captured while traveling to other motor travel extreme. In one aspect, for each image captured, the current position of the stepper motor is saved, the camera is controlled to read the region of interest of the image, and a Focus Measure is calculated. Values are stored to the Focus Measure table. In step 7, the table is scanned or read to determine the best Focus Measure value. In step 8 the AF motor is controlled to move to the location/point where the best Focus Measure was achieved. In step 9 the image is captured by the image detector.

While the invention has been described by way of example and in terms of the specific embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A hand-held, stereoscopic optical viewing device, comprising:
a frame;
at least one pair of refracting telescopes, each having an objective lens and an eyepiece mounted on the frame;
a stereoscopic imaging system having an image detector; and
a manual focusing mechanism which simultaneously focuses the images formed by the objective lens to the eyepiece and to the image detector of the stereoscopic imaging system; and
an automatic focusing mechanism configured to automatically adjust the focus of the images provided to the image detector.

2. The stereoscopic optical viewing device of claim 1, wherein said device is a 3-dimensional imaging system.

3. The stereoscopic optical viewing device of claim 1, wherein said device is a binocular.

4. The stereoscopic optical viewing device of claim 1, wherein said image detector comprises a complementary metal oxide semiconductor (CMOS) photo array.

5. The stereoscopic optical viewing device of claim 1, wherein said image detector comprises a charge coupled device (“CCD”).

6. The stereoscopic optical viewing device of claim 1, wherein said image detector comprises an optical sensor and imaging optics.

7. The stereoscopic optical viewing device of claim 1, wherein the manual focusing mechanism provides fine focus of the images provided to the eyepieces and coarse focusing of the images provided to the image detector.

8. A hand-held stereoscopic system, comprising:
an optical viewing system having a moveable objective lens, a prism and an eyepiece;
an embedded imaging system having an optical sensor to record images and an automatic focusing mechanism for adjusting the focus of images provided to the optical sensor;
wherein the prism provides an image formed by the objective lens to the eyepiece and to the imaging system,
wherein movement of the movable objective lens simultaneously adjusts the focus of the image provided to the eyepiece and to the embedded imaging system, and wherein the automatic focusing mechanism automatically adjusts the focus of the image provided to the optical sensor.

9. A hand-held stereoscopic system of claim 8, wherein said system is a 3-dimensional imaging system.

10. A hand-held stereoscopic system of claim 8, wherein said system is a binocular.

11. A hand-held stereoscopic system of claim 8, wherein said movable objective lens is manually adjustable.

12. A hand-held stereoscopic system of claim 8, wherein said movable objective lens is automatically adjusted.
